(19) United States
(12) Patent Application Publication
(10) Pub. No.: US 2018/0137578 A1
(43) Pub. Date: May 17, 2018

(54) SYSTEM AND METHOD FOR PREDICTION OF DEDUCTION CLAIM SUCCESS BASED ON AN ANALYSIS OF ELECTRONIC DOCUMENTS

(71) Applicant: Vatbox, Ltd., Herzeliya (IL)

(72) Inventors: Noam GUZMAN, Ramat Hasharon (IL); Isaac SAFT, Kfar Neter (IL)

(73) Assignee: Vatbox, Ltd., Herzeliya (IL)

(21) Appl. No.: 15/869,735

(22) Filed: Jan. 12, 2018

Related U.S. Application Data
(63) Continuation-in-part of application No. 14/272,825, filed on May 8, 2014.
Application No. 14/272,825 is a continuation-in-part of application No. PCT/IL2014/050201, filed on Feb. 27, 2014.
(60) Provisional application No. 62/445,249, filed on Jan. 12, 2017.
(60) Provisional application No. 61/820,795, filed on May 8, 2013.
(60) Provisional application No. 61/769,786, filed on Feb. 27, 2013.

(51) Int. Cl. G06Q 40/00; G06K 9/00; G06Q 20/40; G06Q 10/10

(52) U.S. Cl. CPC G06Q 40/123; G06Q 10/10; G06Q 20/401; G06K 9/00469

(57) ABSTRACT

A method and system for predicting a likelihood of success of a potential corporate income tax (CIT) deduction. The method includes analyzing a CIT deduction electronic document to determine at least one transaction parameter, where the analysis includes determining, via digital image recognition, the at least one transaction parameter; retrieving, based on the analysis, at least one CIT deduction success parameter; and determining, based on the analysis and the retrieved at least one CIT deduction success parameter, the likelihood of success of the potential CIT deduction.

### CROSS-REFERENCE TO RELATED APPLICATIONS

This application claims the benefit of U.S. Provisional Application No. 62/445,249, filed on Jan. 12, 2017, the contents of which are hereby incorporated by reference. This application is also a continuation-in-part of U.S. application Ser. No. 14/272,825, filed on May 8, 2014, now pending, which claims the benefit of U.S. Provisional Application No. 61/820,795 filed on May 8, 2013. The Ser. No. 14/272,825 application is also a continuation-in-part of International Application No. PCT/IL2014/050201, filed on Feb. 27, 2014, now pending, which claims the benefit of U.S. Provisional Application No. 61/769,786 filed on Feb. 27, 2013.

All of the applications referenced above are herein incorporated by reference.

### TECHNICAL FIELD

The present invention relates generally to corporate income tax deductions and, more particularly, to predicting corporate income tax deduction success based on electronic documents.

### BACKGROUND

Certain ordinary and necessary business expenditures made by a corporation may be deductible from the corporation's taxable income according to many jurisdictions. These include certain operating expenses, interest payments, employee expenses, insurance premiums, and the like. These deductions can amount to significant amounts of money such that they may have a great influence on a final tax bill of a corporation. For that reason, it is in the best interest of a corporation to try and minimize the amount of tax be paid by submitting documentation related to expenses deductible from a corporate income tax (CIT). Such expenses should be reported to the relevant tax authorities in order to reclaim at least a partial tax refund for the expenses made.

In order to receive a full tax benefit for business expenses, corporations often must devote significant time and resources to gathering relevant expense documentation, organizing the documents, and preparing the documents and related forms to filing. One popular, though expensive, solution is to hire the services of an accounting firm or other similar service provider to handle this important financial matter. One key disadvantage of the existing solutions is that it is difficult and cumbersome for a corporation to track each deductible expense and documentation associated therewith, requiring time and money to calculate and submit the proper files and forms.

Although the existing solutions introduce techniques by which purchase evidences and other documentation are managed, the usage made with this purchase evidences is still limited. For example, systems that enable to identify whether a purchase evidence is authentic or not are already known by the existing solutions. However, the existing solutions lack the ability to classify purchase evidences with respect to a potential for a successful CIT deduction. Further, existing solutions may face challenges in accurately and efficiently identifying purchase evidences when the purchase evidences are in the form of unstructured data.

It would therefore be advantageous to provide a solution that would allow to predict the likelihood of success of a potential CIT deduction.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for predicting a likelihood of success of a potential corporate income tax (CIT) deduction. The method includes analyzing a CIT deduction electronic document to determine at least one transaction parameter, where the analysis includes determining, via digital image recognition, the at least one transaction parameter; retrieving, based on the analysis, at least one CIT deduction success parameter; and determining, based on the analysis and the retrieved at least one CIT deduction success parameter, the likelihood of success of the potential CIT deduction.

Certain embodiments disclosed herein also include a non-transitory computer readable medium having stored thereon causing a processing circuitry to execute a process. The process includes: analyzing a CIT deduction electronic document to determine at least one transaction parameter, where the analysis includes determining, via digital image recognition, the at least one transaction parameter; retrieving, based on the analysis, at least one CIT deduction success parameter; and determining, based on the analysis and the retrieved at least one CIT deduction success parameter, the likelihood of success of the potential CIT deduction.

Certain embodiments disclosed herein also include a system for predicting a likelihood of success of a potential corporate income tax (CIT) deduction. The system includes: a processing circuitry; and a memory, the memory containing instructions that, when executed by the processing circuitry, configure the system to: analyze a CIT deduction electronic document to determine at least one transaction parameter, where the analysis includes determining, via digital image recognition, the at least one transaction parameter; retrieve, based on the analysis, at least one CIT deduction success parameter; and determine, based on the analysis and the retrieved at least one CIT deduction success parameter, the likelihood of success of the potential CIT deduction.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic block diagram of a system for analyzing CIT deduction electronic documents according to an embodiment.

FIG. 2 is a flowchart illustrating processing of CIT deduction electronic documents according to an embodiment.

FIG. 3 is a flowchart illustrating the prediction of a likelihood of success of a CIT deduction according to an embodiment.

FIG. 4 is a flowchart illustrating authentication checking according to an embodiment.

FIG. 5 is a flowchart illustrating eligibility checking according to an embodiment.

FIG. 6 is a flowchart illustrating determination of likelihood of success of a CIT deduction according to an embodiment.

FIG. 7 is a flowchart illustrating a method for creating a structured dataset template based on an electronic document according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

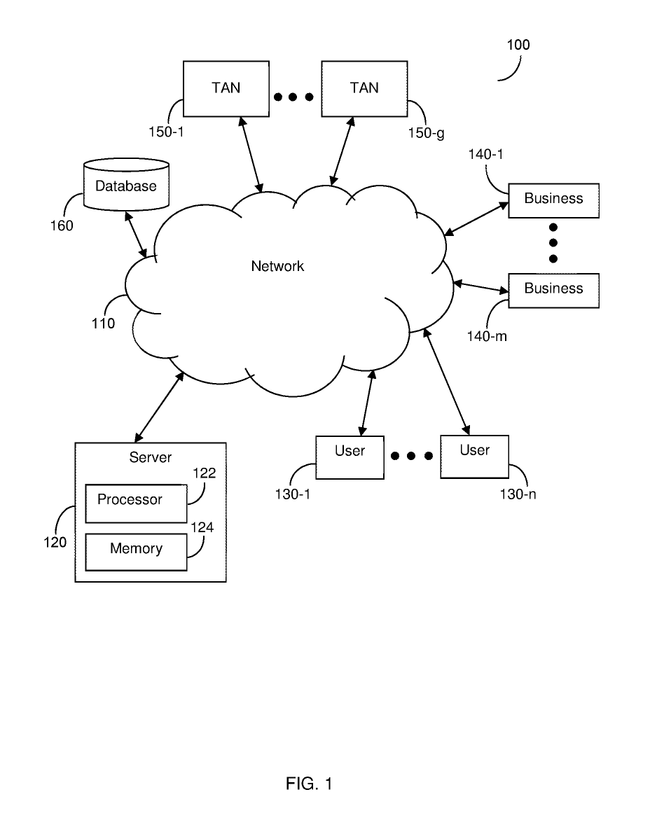

FIG. 1 shows an example schematic diagram of a system for corporate income tax (CIT) deduction 100 according to an embodiment. The system 100 includes a network 110, a server 120, a plurality of user nodes 130-1 through 130-n, a plurality of business nodes 140-1 through 140-m, a plurality of tax authority nodes 150-1 through 150-g, and a database 160. The network 110 can be a local area network (LAN), a wide area network (WAN), a metro area network (MAN), the worldwide web (WWW), the Internet, implemented as wired and/or wireless networks, or any combinations thereof.

The server 120 is communicatively connected to the network 110. The server 120 includes a processing unit further including, e.g., a processor 122 and a memory 124. The system 100 also includes one or more user nodes 130-1 through 130-n (for the sake of simplicity and without limitation, such nodes may be referred to collectively as user nodes 130 or individually as a user node 130), that are also communicatively connected to the network 110. The system 100 further includes one or more business nodes 140-1 through 140-m (for the sake of simplicity and without limitation, such nodes may be referred to collectively as business nodes 140 or individually as a business node 140) that are communicatively connected to the server 120 via the network 110.

A business operating a business node 140 such as, for example, business node 140-1, may be, but is not limited to, a hotel, a shop, a service provider, and the like. One or more tax authority nodes (TANs) 150-1 through 150-g (for the sake of simplicity and without limitation, such nodes may be referred to collectively as TANs 150 or individually as a TAN 150) are also communicatively connected to the server 120 via the network 110. An officer or agent operating a TAN 150 such as, for example, TAN 150-1, may be, but is not limited to, a tax authority agent, an accountant, and the like. Each one of the user nodes 130, the business nodes 140, and the TAN nodes 150 may be a personal computer (PC), a notebook computer, a cellular phone, a smartphone, a tablet device, and the like.

The system 100 also typically includes a database 160 communicatively connected to the server 120. The server 120 may be configured to store information with respect to an applicant in the database 160. Such applicant information may include a user who submitted one or more documents for CIT deductions, the submitted documents for CIT deductions, conditions with respect to laws related to CIT deductions in a variety of jurisdictions, and so on. The conditions related to CIT deductions may include, but are not limited to, a maximum required total purchase price, a list of businesses in which a CIT deduction is possible, a list of which expenses are considered to be deductible for CIT purposes, whether there is an obligation to disclose all information needed with respect to goods that are mentioned in the documents for CIT deductions, whether there is an obligation to disclose all information needed with respect to an applicant who submitted the documents to be utilized for CIT deductions, and the like.

Electronic versions of documents to be utilized for CIT deduction (hereinafter referred to as CIT deduction electronic documents) may include, for example, images of receipts, invoices, canceled checks, or other documents that identify payee, amount, and proof of payment or electronic funds transferred, cash register tapes, account statements, credit card receipts and statements, invoices, and petty cash slips for small cash payments that may be used to substantiate certain elements of the relevant expenses. To qualify for a CIT deduction, these documents must be related to necessary and ordinary business expenses, such as travel, entertainment, gift or transportation expenses. An electronic document representing a CIT deduction electronic document may be, for example, a scanned image of a receipt or invoice.

The server 120 may use the information stored in the database 160 such as by, for example, retrieving information of an applicant required to prove a necessary and ordinary business expenses. Such information may include, but is not limited to, categories of expenses, amounts permitted for certain categories, associated between individuals and corporations, e.g., if in an individual is an employee or customer of a corporation, and the like. According to an embodiment, the information stored in the database 160 may be received from an external source. Such external source may be, but is not limited to, a user node 130 or a business node 140.

When a potential CIT deduction is identified, the server 120 may perform authenticity analysis for one or more CIT deduction electronic documents, received with respect to the information stored in the database 160. According to an embodiment, the server 120 is configured to identify a forgery or a duplicated copy of a CIT deduction electronic document. In an embodiment, the server 120 is configured to analyze each CIT deduction electronic document received to determine its eligibility for a CIT deduction.

According to another embodiment, the server 120 is further configured to identify one or more unacceptable parameters. Parameters may be unacceptable if they are, for example, missing or unclear in the CIT deduction electronic document. The server 120 may also be configured to send a request to perform corrective actions upon identification of one or more unacceptable parameters within the received CIT deduction electronic document. The request may be sent to a user node 130, or to a business node 140. The server 120 is configured to submit the CIT deduction electronic document to a TAN 150 upon identification of an eligible CIT deduction electronic document

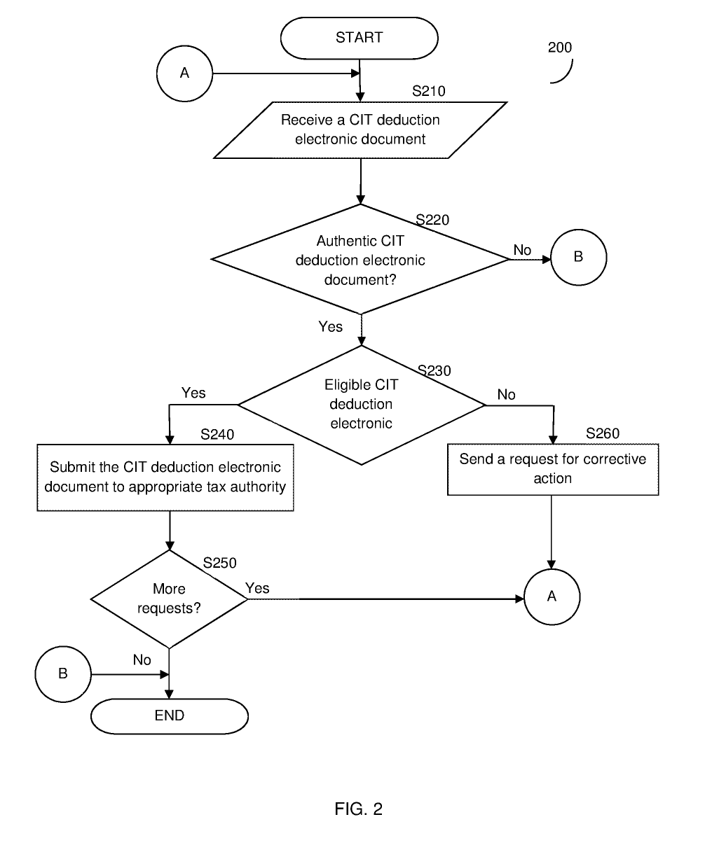

FIG. 2 depicts an example flowchart 200 of a method for CIT deduction electronic document processing according to an embodiment. It should be noted that, although discussion of FIG. 2 may be made with respect to the system 100 described in FIG. 1, the steps of this flowchart may be performed with respect to another system without departing from the scope of the disclosed embodiments.

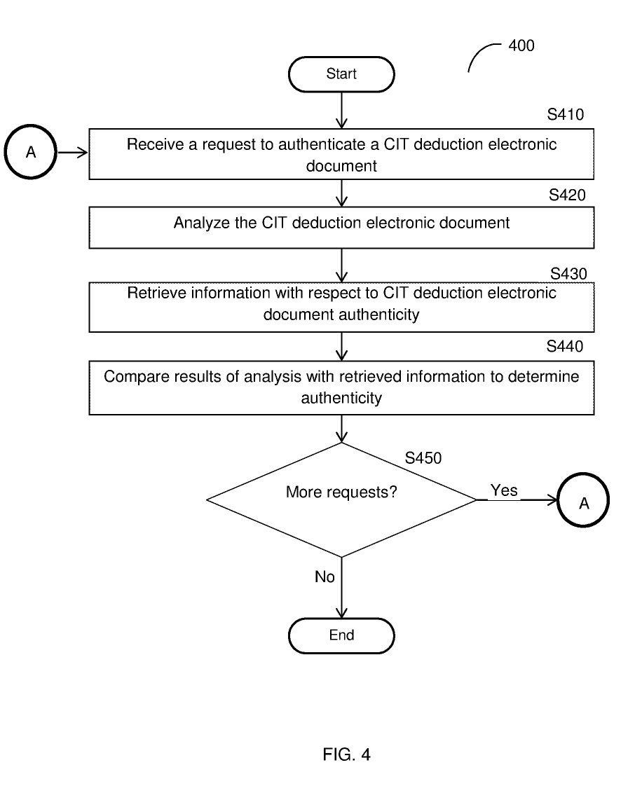

At S210, at least one CIT deduction electronic document is received. According to an embodiment, the CIT deduction electronic document may be provided by a business node 140 or, alternatively, by a user node 130. At S220, it is checked whether each CIT deduction electronic document is an authentic CIT deduction electronic document and, if so, execution continues with S230; otherwise, execution terminates. The check may be made with respect to information stored in a database (e.g., database 160). Authentication checking is discussed further herein below with respect to FIG. 4.

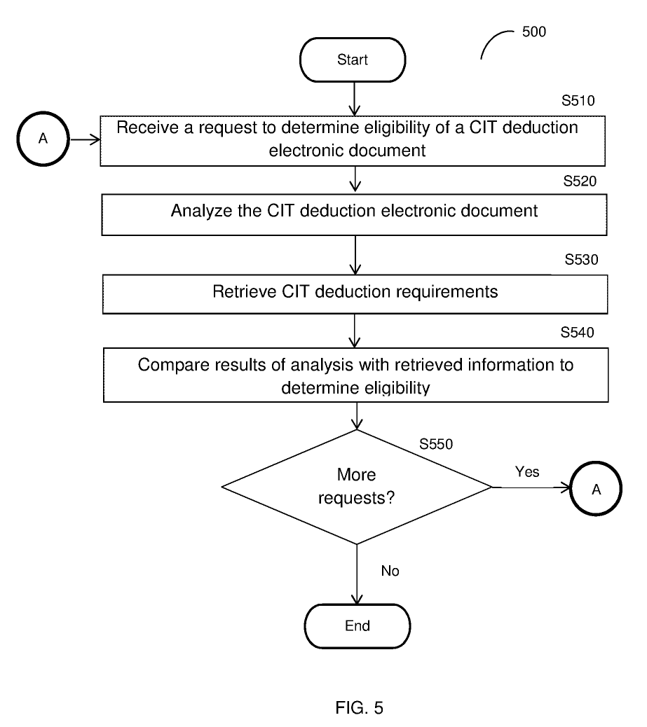

At S230, it is checked whether each CIT deduction electronic document is an eligible CIT deduction electronic document and, if so, execution continues with S240; otherwise, execution continues with S260. Eligibility checking is discussed further herein below with respect to FIG. 5.

At S240, the CIT deduction electronic document is submitted to an appropriate or otherwise preferred TAN 150. The TAN selection may be based on factors such as, but not limited to, effectiveness in receiving refunds, location, and so on. At S250, it is checked whether there are additional requests and, if so, execution continues with S210; otherwise, execution terminates.

At S260, a request for corrective action with respect to the CIT deduction electronic document is sent upon identification of an ineligible CIT deduction electronic document. The request may be sent to the user node 130 or the business node 140 that provided the CIT deduction electronic document. Corrective action may include, for example, re-uploading an image of the receipt, providing a new receipt, and the like. After corrective action has been taken, execution continues with S210.

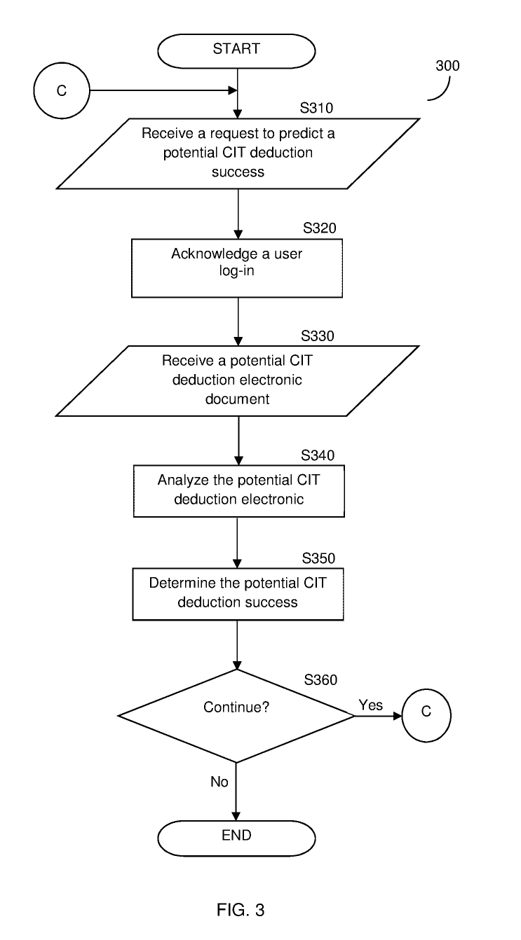

FIG. 3 depicts an example flowchart 300 for predicting a likelihood of success of a potential CIT deduction reclaim according to an embodiment. It should be noted that, although discussion of FIG. 3 will be made with respect to the system 100 described in FIG. 1, the steps of this flowchart may be performed with respect to another system without departing from the scope of the disclosed embodiments.

At S310, a request to predict the likelihood of success of a potential CIT deduction for a CIT deduction electronic document is received. The request may be received through a log-in process of a user on a user node 130, thereby the “prediction” request is initiated and sent by a user node 130.

At S320, a user log-in is acknowledged via identification of a user node (e.g., user node 130). Such acknowledgment may include verification of the user credentials against detailed saved in the database 160. At S330, the CIT deduction electronic document is received from, for example, the user node 130. Alternatively, the CIT deduction electronic document may be retrieved from a database (e.g., database 160).

As noted above, the database 160 maintains information for CIT deduction such as, for example, information with respect to users, one or more CIT deduction electronic documents, conditions with respect to laws related to CIT deductions in a variety of jurisdictions, etc. The conditions related to CIT deduction may include, but are not limited to, a minimum required total purchase price, the type of expense incurred, a list of businesses in which a CIT deduction is possible, whether there is an obligation to disclose all information needed with respect to goods that are mentions in the CIT deduction electronic document, whether there is an obligation to disclose all information needed with respect to an applicant who submitted the CIT deduction electronic document, whether the potential CIT deduction may depends on a non-commercial purchase of goods, and so on.

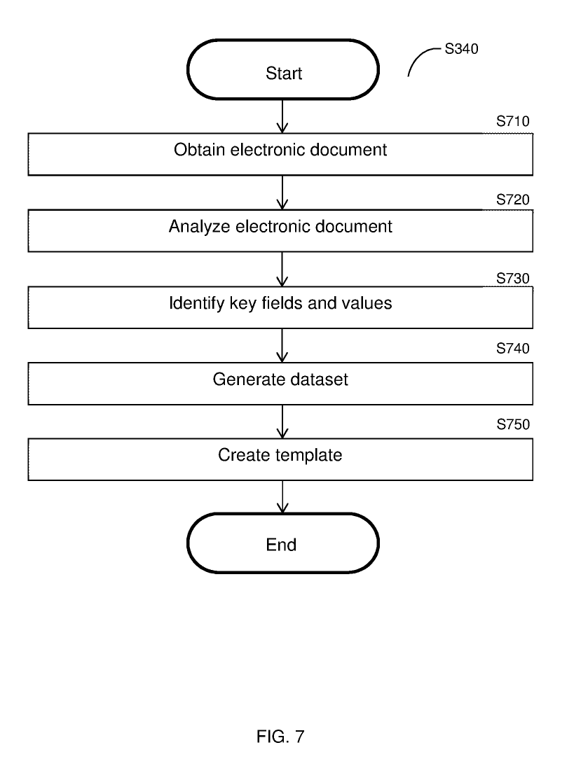

At S340, the CIT deduction electronic document is analyzed to determine the user eligibility for the CIT deduction. Analysis of a CIT deduction electronic document may include, but is not limited to, scanning the document, determining information contained in the document based on digital image and/or word recognition, receiving information from a user or business, and so on. In an embodiment, S340 may include creating a structured dataset template based on the CIT deduction electronic document by identifying key fields and values in the unstructured data included in the CIT deduction electronic document. The structured dataset template can be used to more efficiently analyze the contents of the document. Such an analysis is explained in further detail in FIG. 7.

According to an embodiment, a target country in which the potential CIT deduction electronic document is processed may be identified. Additionally, it may be checked whether the CIT deduction electronic document complies with laws in the target country. It is determined if the CIT deduction electronic document does not support one or more conditions required in order to receive the CIT deduction in the target country. Such identification will reduce the likelihood of success of the potential CIT deduction. The target country may be a value included, for example, in a “location of transaction” field of the created template.

According to another embodiment, the user eligibility for the CIT deduction is determined, for example, with respect to a purchase type for which the CIT deduction is requested. It is determined if the purchase type is a business expenditure of a business included in the list of businesses in which a CIT deduction is possible. Moreover, it is checked whether the minimum purchase as it is recorded in the CIT deduction electronic document is suitable based on, e.g., the minimum required total purchase price for the CIT deduction electronic document.

According to yet another embodiment, one or more errors in the CIT deduction electronic document may be identified. An error may be, but is not limited to, missing or partial information, unclear information, a combination thereof, etc. Such an error may occur when information with respect to the applicant who submitted the CIT deduction electronic document and/or information with respect to goods mentioned in the CIT deduction electronic document is not disclosed appropriately. As a non-limiting example, if the price of the goods is blurred or otherwise obscured on the receipt, an error may be identified. Identification of one or more errors will reduce the likelihood of success of the potential CIT deduction. In such a case, a request for corrective action necessary to produce a qualified CIT deduction electronic document and increase the success rate may be sent, as described in greater detail herein above.

It should be noted that the CIT deduction electronic document is analyzed with respect to information that may be retrieved from a database (e.g., the database 160). Such information may be related, for example, to the country where the CIT deduction electronic document is issued, the residence of the user, one or more parameters related to the purchased product, and combinations thereof. It also should be noted that some countries require an original CIT deduction electronic document and, if such an original receipt is not received, the likelihood of success for a CIT deduction are significantly reduced.

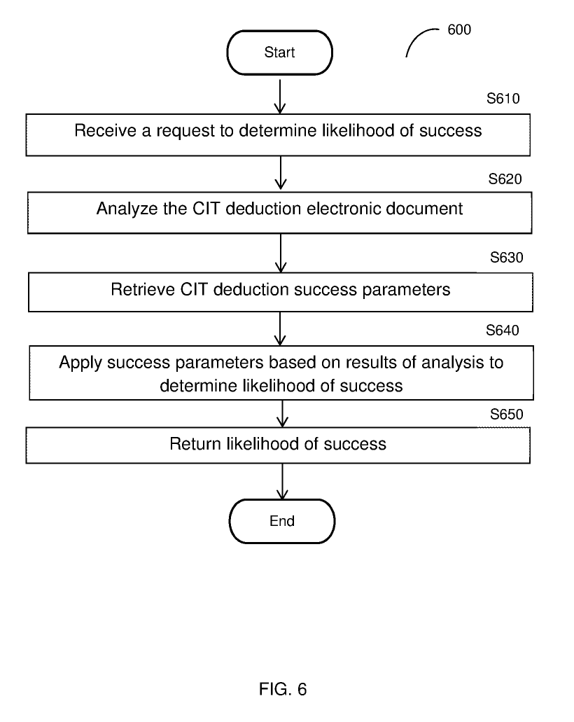

At S350, the likelihood of success of the CIT deduction is determined with respect to the CIT deduction electronic document analysis and the retrieved information. Determination of likelihood of success of CIT deductions is discussed further herein below with respect to FIG. 6. At S360, it is checked whether there are additional requests and if so, execution continues with S310; otherwise, execution terminates.

A person of ordinary skill in the art would readily appreciate that the operation of the CIT deduction processing as described in FIG. 2 and the prediction of CIT deduction electronic document success as described in FIG. 3 may be utilized in tandem without separating from the scope of either embodiment.

FIG. 4 is a flowchart illustrating authentication checking according to an embodiment. At S410, a request to authenticate a CIT deduction electronic document is received. At S420, the CIT deduction electronic document is analyzed to determine document information that may be pertinent to authenticity. Analysis of a CIT deduction electronic document may include, but is not limited to, scanning the document, determining information contained in the document based on digital image and/or word recognition, receiving information from a user or business, and so on. Information that is pertinent to authenticity may be, but is not limited to, items sold, invoice designation of items, store name, store address, and the like.

In an embodiment, S420 may include creating a structured dataset template based on the CIT deduction electronic document by identifying key fields and values in the unstructured data included in the CIT deduction electronic document. The structured dataset template can be used to more efficiently analyze the contents of the document. Such an analysis is explained in further detail in FIG. 7.

At S430, information pertinent to CIT deduction electronic document authenticity checking is retrieved. In an embodiment, such information may be retrieved from a database (e.g., database 160). Information that is pertinent to authenticity checking may include, but is not limited to, statutory formal requirements and classifications of goods and/or services. Classifications of goods and/or may be utilized, for example, to determine if the information analyzed from the CIT deduction electronic document with respect to specific goods and/or services sold generally reflects the type of invoice. In an example implementation, the information may be retrieved based on a jurisdiction indicated in a “location” field of the template.

At S440, the results of the analysis are compared with the retrieved information to determine authenticity. If the information matches or is otherwise sufficiently matching, the receipt may be determined as authentic. Sufficiency of matching may be predefined by, e.g., a tax authority. At S450, it is checked whether more requests have been received. If so, execution continues with S410. Otherwise, execution terminates. In an example implementation, the retrieved information may be compared to values in respective fields of the template.

As a non-limiting example, a CIT deduction electronic document is received. The CIT deduction electronic document is analyzed and it is determined that the CIT deduction electronic document indicates a purchase of a book. In this example, books do not qualify for CIT deduction since they are not considered to be a necessary and ordinary expense for the relevant corporation submitting the documents. Information indicating either that the store that sold the book or the invoice itself deals with electronics, and not books, is retrieved. Upon comparing the result of the analysis with the results of the retrieval, it is determined that the category of the good (book) does not match the category of the invoice (electronics). As a result, the receipt is found to be unauthentic.

FIG. 5 is an example flowchart illustrating eligibility checking according to an embodiment. At S510, a request to determine eligibility of a CIT deduction electronic document is received. At S520, the CIT deduction electronic document is analyzed to determine receipt information that may be pertinent to eligibility. Analysis of a CIT deduction electronic document may include, but is not limited to, scanning the receipt, determining information contained in the CIT deduction electronic document based on digital image and/or word recognition, receiving information from a user or business, creating a template based on the CIT deduction electronic document, etc. Information pertinent to eligibility may include, but is not limited to, types of items sold, price of each item, total price of items, location of business, date of purchase, and the like.

At S530, CIT deduction requirements are retrieved. In an embodiment, these requirements may be retrieved from a database (e.g., database 160) being pre-populated with such requirements. CIT deduction requirements may include, but are not limited to, inclusion in an eligible category of goods, minimum required purchase total, time period for eligibility, category of related expanse, and the like.

At S540, the results of the analysis are compared to the results of the retrieval to determine whether the receipt is eligible for a CIT deduction. If the information matches or is otherwise sufficiently matching, the receipt may be determined as eligible for a CIT deduction. Sufficiency of matching may be predefined by, e.g., a tax authority. At S550, it is checked whether additional requests have been received. If so, execution continues with S510. Otherwise, execution terminates.

As a non-limiting example, a CIT deduction electronic document, such as a scanned image of a receipt is received. The receipt is analyzed, and it is determined that the receipt indicates a purchase of a book. Information regarding classifications of goods and services that do not qualify for a CIT deduction is retrieved. This classification information indicates that books do not qualify for the CIT deduction. Upon comparing the result of the analysis with the results of the retrieval, it is determined that the receipt for purchase of a book is ineligible for a CIT deduction.

FIG. 6 is an example flowchart S350 describing in further detail the step of determination of likelihood of success according to an embodiment. At S610, a request to determine likelihood of success for obtaining a deduction based on a CIT deduction electronic document is received.

At S620, the CIT deduction electronic document is analyzed to determine receipt information that may be pertinent to likelihood of success. Analysis of a CIT deduction electronic document, such as a receipt for a good, may include, but is not limited to, scanning the receipt, determining information contained in the receipt based on digital image and/or word recognition, receiving information from a user or business, etc. Information that may be pertinent to likelihood of success may include, but is not limited to, information pertinent to authentication, information pertinent to eligibility for a CIT deduction, markings demonstrating whether the receipt is an original, whether there is blurring or other difficulty reading the receipt that may result in an error as discussed further herein above, and the like. Information pertinent to authenticity and information pertinent to eligibility are discussed further herein above with reference to FIGS. 4 and 5, respectively.

At S630, CIT deduction parameters are retrieved. In an embodiment, such parameters may be retrieved from a database (e.g., database 160). In an embodiment, CIT deduction success parameters may be numerical values (e.g., 0, 1, 2, 0.5, etc.) or predefined weights associated with certain conditions that can be multiplied with other success parameters to determine a likelihood of success of receiving a CIT deduction. In an embodiment, such weights are each between 0 and 1 inclusive. In another example embodiment, the CIT deduction success parameters may be assigned with a binary value ‘1’ or ‘0’. For example, information indicating that a CIT deduction electronic document is authentic may be associated with a CIT deduction success parameter having a value of 1, while information indicating that a CIT deduction electronic document is not authentic may be associated with a CIT deduction success parameter having a value of 0.

At S640, the results of the analysis are used to determine which success parameters to apply based on the satisfied or unsatisfied condition. The condition is determined based on the refund regulations governed by a certain country. Then, the determined parameters are applied to find the likelihood of success. Application of success parameters may include multiplying such parameters or utilizing statistical measures on such parameters to obtain a success measure. This success measure may be, e.g., a percentage, a numerical value, and the like determining a likelihood of success for a CIT deduction. At S650, the success measure is returned. In an embodiment, a refund success indication is produced based on the success measure indicating the eligibility for a refund. This may include comparing the computed or otherwise determined success measure to a predefined threshold. If the measure exceeds the threshold, the user is eligible for a refund; otherwise, the user is ineligible.

As a non-limiting example (“Example 1”) of determination of likelihood of success, a request to determine a likelihood of success for a receipt is received. The receipt is scanned and information indicating that the receipt is authentic, that the receipt is eligible, and that the receipt is obscured along a small portion of the top edge are determined. The authenticity, eligibility, or both, may be determined based on a structured dataset template created for the receipt. Success parameters related to these general categories (i.e., authenticity, eligibility, and obscurity) are retrieved from a database (e.g., database 160).

In this example, an authentic CIT deduction electronic document is associated with a success parameter having a value equal to 1, an unauthentic CIT deduction electronic document is associated with a success parameter having a value equal to 0, an eligible CIT deduction electronic document is associated with a success parameter having a value equal to 1, and an ineligible CIT deduction electronic document is associated with a success parameter having a value equal to 0. Additionally, obscurity is associated with a success parameter that varies depending on the area of the CIT deduction electronic document that is obscured relative to the total receipt area and upon the location of the obscurity relative to the rest of the receipt. In this case, since there is only a small relative area of obscurity, and the obscurity is not likely to be blocking significant information (the topmost edge of a receipt frequently lacks significant information), the success parameter related to obscurity is retrieved as 0.9.

Based on the success parameters, the likelihood of success may be determined. In this example, determination is based on multiplication of the success parameters. Thus, (1)*(1)*(0.9)=0.9, which may be returned as, e.g., 0.9 or as 90%. This indicates a 90% likelihood of successfully receiving a CIT deduction based on the analyzed CIT deduction electronic document.

As another limiting example (“Example 2”), a CIT deduction electronic document as in Example 1 is determined to be ineligible for a refund rather than eligible. In Example 2, this ineligibility results in a success parameter associated with eligibility of 0. Consequently, the likelihood of success is determined to equal (1)*(0)*(0.9)=0. Therefore, in Example 2, the likelihood of success is determined to be 0%.

FIG. 7 is an example flowchart S340 illustrating a method for creating a structured dataset template based on an electronic document according to an embodiment.

At S710, an electronic document is obtained. Obtaining the electronic document may include, but is not limited to, receiving the electronic document (e.g., receiving a scanned image).

At S720, the electronic document is analyzed. The analysis may include, but is not limited to, using optical character recognition (OCR) to determine characters in the electronic document.

At S730, based on the analysis, key fields and values in the electronic document are identified. The key field may include, but are not limited to, merchant's name and address, date, currency, good or service sold, a transaction identifier, an invoice number, and so on. An electronic document may include unnecessary details that would not be considered to be key values. As an example, a logo of the merchant may not be required and, thus, is not a key value. In an embodiment, a list of key fields may be predefined, and pieces of data that may match the key fields are extracted. Then, a cleaning process is performed to ensure that the information is accurately presented. For example, if the OCR would result in a data presented as “1211212005”, the cleaning process will convert this data to 12/12/2005. As another example, if a name is presented as “Mo$den”, this will change to “Mosden”. The cleaning process may be performed using external information resources, such as dictionaries, calendars, and the like.

In a further embodiment, it is checked if the extracted pieces of data are completed. For example, if the merchant name can be identified but its address is missing, then the key field for the merchant address is incomplete. An attempt to complete the missing key field values is performed. This attempt may include querying external systems and databases, correlation with previously analyzed invoices, or a combination thereof. Examples for external systems and databases may include business directories, Universal Product Code (UPC) databases, parcel delivery and tracking systems, and so on. In an embodiment, S730 results in a complete set of the predefined key fields and their respective values.

At S740, a structured dataset is generated. The generated structured dataset includes the identified key fields and values.

At S750, based on the structured dataset, a template is created. The created template is a data structure including a plurality of fields and corresponding values. The corresponding values include transaction parameters identified in the dataset. The fields may be predefined.

In an embodiment, creating the template includes analyzing the generated structured dataset to identify transaction parameters such as, but not limited to, at least one entity identifier (e.g., a consumer enterprise identifier, a merchant enterprise identifier, or both), information related to the transaction (e.g., a date, a time, a price, a type of good or service sold, etc.), or both. In a further embodiment, analyzing the structured dataset may also include identifying the transaction based on the dataset.

The transaction parameters can be used to determine if a CIT deduction electronic document is likely to be successful in acquiring a tax deduction. For example, if the transaction parameters within the document indicate that the document is an invoice directed towards an employee's hotel stay, and, based on a predetermined list, a hotel stay has been determined to be a necessary and ordinary business expense, the transaction parameters may be used to determine that the invoice would be likely successful when used to request a CIT deduction.

Creating templates from electronic documents allows for faster processing of documents due to the structured nature of the created templates. For example, query and manipulation operations may be performed more efficiently on structured datasets than on datasets lacking such structure. Further, organizing information from electronic documents into structured datasets, the amount of storage required for saving information contained in electronic documents may be significantly reduced. Electronic documents are often images that require more storage space than datasets containing the same information. For example, datasets representing data from 100,000 image electronic documents can be saved as data records in a text file. A size of such a text file would be significantly less than the size of the 100,000 images.

Example embodiments and implementations for creating structured dataset templates are described further in U.S. patent application Ser. No. 15/361,934 filed on Nov. 28, 2016, assigned to the common assignee, the contents of which are hereby incorporated by reference.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiments and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for predicting a likelihood of success of a potential corporate income tax (CIT) deduction, comprising:
analyzing a CIT deduction electronic document to determine at least one transaction parameter, wherein the analysis includes determining, via digital image recognition, the at least one transaction parameter;
retrieving, based on the analysis, at least one CIT deduction success parameter; and
determining, based on the analysis and the retrieved at least one CIT deduction success parameter, the likelihood of success of the potential CIT deduction.

2. The method of claim 1, wherein each CIT deduction success parameter is defined with respect to at least one requirement for CIT deductions in a jurisdiction, the at least one requirement including at least one of: a maximum required total purchase price, a list of types of businesses in which a CIT deduction is possible, expenses that are considered to be deductible from CITs, an obligation to disclose information related to goods mentioned in documents for CIT deductions, and an obligation to disclose all information related to an applicant submitting documents for CIT deductions.

3. The method of claim 1, further comprising:
determining authenticity of the CIT deduction electronic document.

4. The method of claim 1, further comprising:
determining eligibility for the CIT deduction electronic document.

5. The method of claim 1, wherein the CIT deduction electronic document is an image of at least one of: a receipt, a canceled check, a price amount, a proof of payment, a proof of electronic funds transferred, a cash register tape, an account statement, a credit card receipt, a credit card statement, an invoice, and a petty cash slip.

6. The method of claim 1, wherein determining the at least one transaction parameter further comprises:
identifying, in the CIT deduction electronic document, at least one key field and at least one value;
creating, based on the CIT deduction electronic document, a structured dataset, wherein the created structured dataset includes the at least one key field and the at least one value;
analyzing the created structured dataset template, wherein the at least one transaction parameter is determined based on the analysis; and
creating a template for the CIT deduction electronic document, wherein the template is a structured dataset including the determined at least one transaction parameter, wherein the likelihood of success is determined based further on the template.

7. The method of claim 6, wherein identifying the at least one key field and the at least one value further comprises:
analyzing the CIT deduction electronic document to determine data in the CIT deduction electronic document; and
extracting, based on a predetermined list of key fields, at least a portion of the determined data, wherein the at least a portion of the determined data matches at least one key field of the predetermined list of key fields.

8. The method of claim 7, wherein analyzing the CIT deduction electronic document further comprises:
performing optical character recognition on the CIT deduction electronic document.

9. The method of claim 6, wherein determining the likelihood of success further comprises:
comparing each of at least one portion of the structured dataset template to the at least one CIT deduction success parameter.

10. The method of claim 1, wherein the analysis further includes determining whether a portion of the CIT deduction electronic document is obscured, wherein the at least one CIT deduction success parameter includes at least one obscurity success parameter, wherein each obscurity success parameter defines an effect of a relative obscurity of an obscured portion of the electronic document on the likelihood of success.

11. A non-transitory computer readable medium having stored thereon instructions for causing one or more processing units to perform a process, the process comprising:
analyzing a CIT deduction electronic document to determine at least one transaction parameter, wherein the analysis includes determining, via digital image recognition, the at least one transaction parameter;
retrieving, based on the analysis, at least one CIT deduction success parameter; and
determining, based on the analysis and the retrieved at least one CIT deduction success parameter, the likelihood of success of the potential CIT deduction.

12. A system for predicting a likelihood of success of a potential corporate income tax (CIT) deduction, comprising:
a processing circuitry; and
a memory, the memory containing instructions that, when executed by the processing circuitry, configure the system to:
analyze a CIT deduction electronic document to determine at least one transaction parameter, wherein the analysis includes determining, via digital image recognition, the at least one transaction parameter;
retrieve, based on the analysis, at least one CIT deduction success parameter; and
determine, based on the analysis and the retrieved at least one CIT deduction success parameter, the likelihood of success of the potential CIT deduction.

13. The system of claim 12, wherein each CIT deduction success parameter is defined with respect to at least one requirement for CIT deductions in a jurisdiction, the at least one requirement including at least one of: a maximum required total purchase price, a list of types of businesses in which a CIT deduction is possible, expenses that are considered to be deductible from CITs, an obligation to disclose information related to goods mentioned in documents for CIT deductions, and an obligation to disclose all information related to an applicant submitting documents for CIT deductions.

14. The system of claim 12, wherein the system is further configured to:
determine authenticity of the CIT deduction electronic document.

15. The system of claim 12, wherein the CIT deduction electronic document is an image of at least one of: a receipt, a canceled check, a price amount, a proof of payment, a proof of electronic funds transferred, a cash register tape, an account statement, a credit card receipt, a credit card statement, an invoice, and a petty cash slip.

16. The system of claim 12, wherein the system is further configured to:
identify, in the CIT deduction electronic document, at least one key field and at least one value;
create, based on the CIT deduction electronic document, a structured dataset, wherein the created structured dataset includes the at least one key field and the at least one value;
analyze the created structured dataset template, wherein the at least one transaction parameter is determined based on the analysis; and
create a template for the CIT deduction electronic document, wherein the template is a structured dataset including the determined at least one transaction parameter, wherein the likelihood of success is determined based further on the template.

17. The system of claim 16, wherein the system is further configured to:
analyze the CIT deduction electronic document to determine data in the CIT deduction electronic document; and
extract, based on a predetermined list of key fields, at least a portion of the determined data, wherein the at least a portion of the determined data matches at least one key field of the predetermined list of key fields.

18. The system of claim 17, wherein the system is further configured to:
perform optical character recognition on the CIT deduction electronic document.

19. The system of claim 18, wherein the system is further configured to:
compare each of at least one portion of the structured dataset template to the at least one CIT deduction success parameter.

20. The system of claim 12, wherein the analysis further includes determining whether a portion of the CIT deduction electronic document is obscured, wherein the at least one CIT deduction success parameter includes at least one obscurity success parameter, wherein each obscurity success parameter defines an effect of a relative obscurity of an obscured portion of the electronic document on the likelihood of success.
